(19) United States
(12) Patent Application Publication
(10) Pub. No.: US 2015/0019293 A1
(43) Pub. Date: Jan. 15, 2015

(54) SYSTEM AND METHOD FOR PRIVACY COMPLIANT GIS FILE FORMAT DELIVERY SYSTEM FOR PAYMENT DATA

(71) Applicant: MasterCard International Incorporated, Purchase, NY (US)

(72) Inventor: Justin X. HOWE, Oakdale, NY (US)

(21) Appl. No.: 13/938,703

(22) Filed: Jul. 10, 2013

(51) Int. Cl. G06Q 30/02

(52) U.S. Cl. CPC G06Q 30/0205
USPC 705/7.34

(57) ABSTRACT

A method for providing characteristic payments data includes: storing a plurality of transaction data entries, each data entry including transaction data, consumer information, merchant information, and a geographic location; receiving a request for characteristics, the request including a characteristic metric and specified geographic area; identifying a subset of data entries, where the geographic location is included in the specified geographic area; identifying the characteristic metric based on at least one of: the transaction data, consumer information, and merchant information of each data entry in the subset; generating a data file illustrating the identified characteristic metric as applied to the specified geographic area, wherein the data file is of a geographic information system (GIS) file format; and transmitting the generated data file in response to the received request for characteristics.

### FIELD

The present disclosure relates to the providing of characteristic payments data, specifically the providing of a data file of a geographic information system (GIS) file format including characteristic data for a plurality of payment transactions.

### BACKGROUND

Merchants, municipalities, urban planners, marketers, and others are often interested in data and trends regarding payment transactions and the consumers and merchants involved in them with respect to geographical areas. Providing such information, such as demographics of a particular consumer or a geographic location of a particular transaction, may not be possible without compromising consumer privacy.

Current methods and systems for providing payments data based on geographic location, while maintaining consumer privacy, often result in data that is overbroad and lacks specificity with regards to both the payments data as well as the geographic data. In addition, many such methods and systems may provide results in the form of raw data, which requires significant analysis and processing by parties requesting the information. Thus, there is a need for a technical solution to provide payments data and characteristic information regarding payment transactions in a standard industry format that maintains privacy of both consumers and merchants involved in the payment transactions.

### SUMMARY

The present disclosure provides a description of a system and method for the providing of characteristic payments data.

A method for providing characteristic payments data includes: storing, in a transaction database, a plurality of transaction data entries, wherein each transaction data entry includes data related to a financial transaction including at least transaction data, consumer information, merchant information, and a geographic location; receiving, by a receiving device, a request for characteristics, wherein the request for characteristics includes at least one characteristic metric and a specified geographic area; identifying, by a processing device, a subset of the plurality of transaction data entries, wherein the geographic location included in each transaction data entry in the subset is included in the specified geographic area; identifying, by the processing device, the at least one characteristic metric based on at least one of: the transaction data, consumer information, and merchant information of each transaction data entry of the identified subset of the plurality of transaction data entries; generating, by the processing device, a data file illustrating the identified at least one characteristic metric as applied to the specified geographic area, wherein the data file is of a geographic information system (GIS) file format; and transmitting, by a transmitting device, the generated data file in response to the received request for characteristics.

A system for providing characteristic payments data includes a transaction database, a receiving device, a processing device, and a transmitting device. The transaction database is configured to store a plurality of transaction data entries, wherein each transaction data entry includes data related to a financial transaction including at least transaction data, consumer information, merchant information, and a geographic location. The receiving device is configured to receive a request for characteristics, wherein the request for characteristics includes at least one characteristic metric and a specified geographic area. The processing device is configured to: identify a subset of the plurality of transaction data entries, wherein the geographic location included in each transaction data entry in the subset is included in the specified geographic area, identify the at least one characteristic metric based on at least one of: the transaction data, consumer information, and merchant information of each transaction data entry of the identified subset of the plurality of transaction data entries, and generate a data file illustrating the identified at least one characteristic metric as applied to the specified geographic area, wherein the data file is of a geographic information system (GIS) file format. The transmitting device is configured to transmit the generated data file in response to the received request for characteristics.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the providing of characteristic payments data while maintaining consumer and merchant privacy in accordance with exemplary embodiments.

FIG. 2 is a block diagram illustrating the processing server of FIG. 1 for the providing of characteristic payments data in accordance with exemplary embodiments.

FIG. 3 is a flow diagram illustrating a method for the providing of a privacy compliant data file including characteristic metrics of payments data in accordance with exemplary embodiments.

FIGS. 4 and 5 are illustrations of characteristic payments data illustrated by a geographic information system data file in accordance with exemplary embodiments.

FIG. 6 is a flow chart illustrating an exemplary method for providing characteristic payments data in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated under the names MasterCard®, VISA®, Discover®, American Express®, etc.

Personally identifiable information (PII)—PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. The present disclosure provides for methods and systems where the processing server 102 does not possess any personally identifiable information. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the processing server 102 may not possess the PII or be able to decrypt the encrypted PII.

### System for Providing Privacy Compliant Characteristic Payments Data

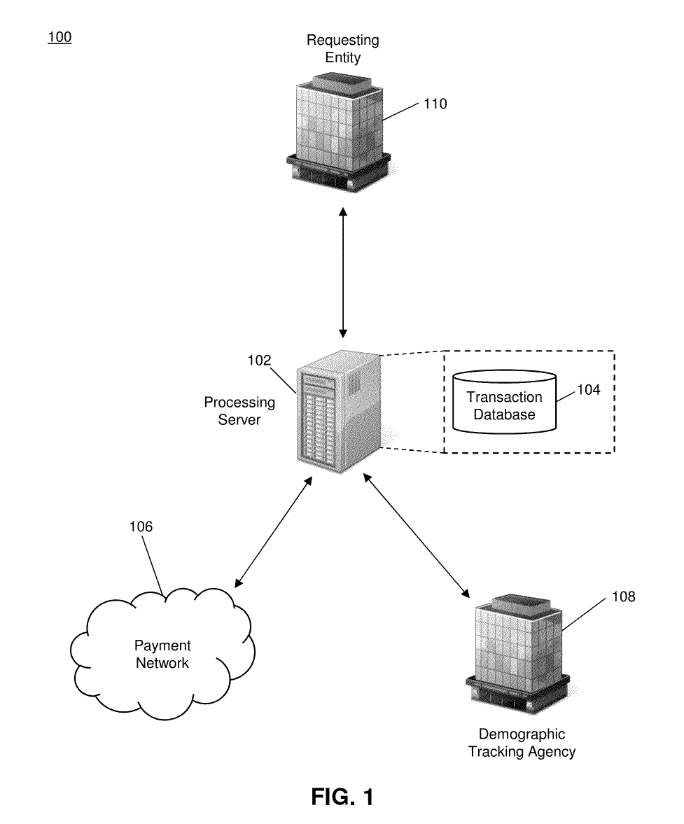

FIG. 1 illustrates a system 100 for providing characteristic payment data in a geographic information system (GIS) file format that is compliant with the privacy of both consumers and merchants.

A processing server 102, discussed in more detail below, may include a transaction database 104 configured to store a plurality of transaction data entries. Each transaction data entry may include data related to a payment transaction (e.g., a financial transaction) including at least transaction data, consumer information, merchant information, and a geographic location. The transaction data entries, discussed in more detail below may be stored based on data provided by an external party, such as a payment network 106, which may have been the payment network used to process the related payment transactions. In some embodiments, the processing server 102 may be part of the payment network 106, and may retain the data necessary for storing a related transaction data entry during processing of the payment transaction. In exemplary embodiments, each transaction data entry contains no personally identifiable information (PII).

The transaction data included in each transaction data entry may include data related to the payment transaction. The consumer information may include information associated with a consumer involved in the related payment transaction. In an exemplary embodiment, the consumer information may contain no PII of the associated consumer. In some embodiments, the consumer information may be bucketed, encrypted, or otherwise processed to prevent the information from being personally identifiable to the associated consumer. In one embodiment, each transaction data entry may represent multiple payment transactions among a plurality of consumers, to prevent consumer information from being personally identifiable.

The merchant information may include information associated with a merchant involved in the related payment transaction, and may, in an exemplary embodiment, not include any potentially identifiable information to individually identify the associated merchant. The geographic location included in each transaction data entry may be the geographic location where the related payment transaction took place. It will be apparent to persons having skill in the relevant art that the geographic location may represent the location of the initiation, conducting, or finalization of the financial transaction, or any other stage suitable for use in performing the functions as discussed herein.

In some instances, the consumer information included in each transaction data entry of the transaction database 104 may not initially include demographic data. For example, the processing server 102 may receive the consumer information from the payment network 106, which may include as little as a consumer identifier (e.g., an alphanumeric string associated with a particular consumer). The processing server 102 may receive demographic information associated with each consumer (e.g., identified by the consumer identifier) from a demographic tracking agency 108. The demographic tracking agency 108 may provide the demographic information, which may not include any PII, and the processing server 102 may store the demographic information in the associated transaction data entry. It will be apparent to persons having skill in the relevant art that additional information included in each transaction data entry may be obtained in a similar fashion, such as by obtaining the merchant information via a third party.

The processing server 102 may receive a request for characteristic payments data from a requesting entity 110, such as a merchant, marketer, urban planner, etc. The request may include at least one characteristic metric and a geographic area for which the metric is to be identified and/or applied. For example, the requesting entity 110 may request a file illustrating the transaction density for food service transactions in the state of Hawaii. The processing server 102 may receive the request, identify the requested characteristic metric in the request, and then identify the characteristic metric based on the information included in at least one of the transaction data, consumer information, and merchant information for each transaction data entry related to a financial transaction occurring in the requested geographic area.

Once the requested metric or metrics have been identified, the processing server 102 may generate a data file illustrating the identified metric(s) as applied to the geographic area specified in the request. In an exemplary embodiment, the data file may be of a GIS file format, such as a shape file or a raster file. Methods for generating a GIS-suitable file format to represent metrics applied to a geographic area will be apparent to persons having skill in the relevant art. Once the data file has been generated, the processing server 102 may transmit the generated data file to the requesting entity 110 as a response to the earlier-received request.

### Processing Device

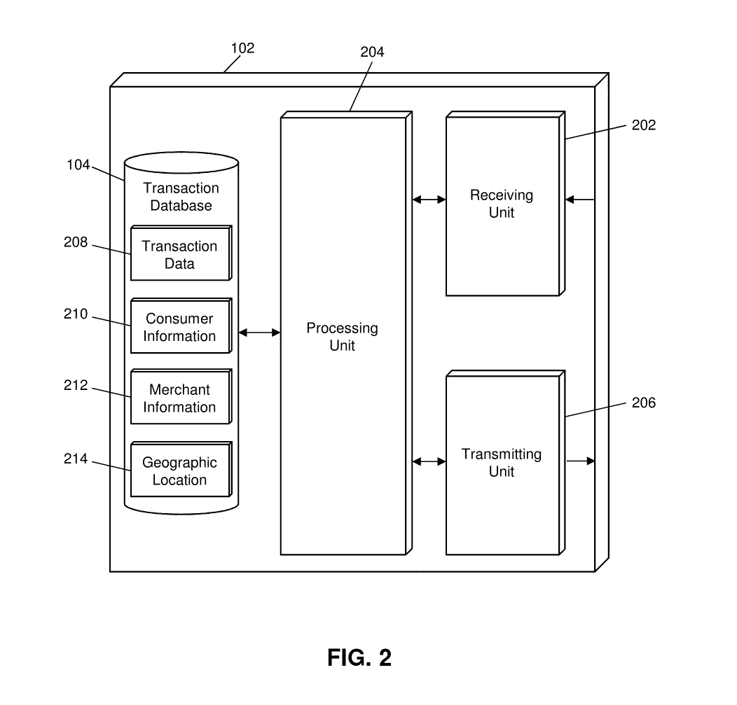

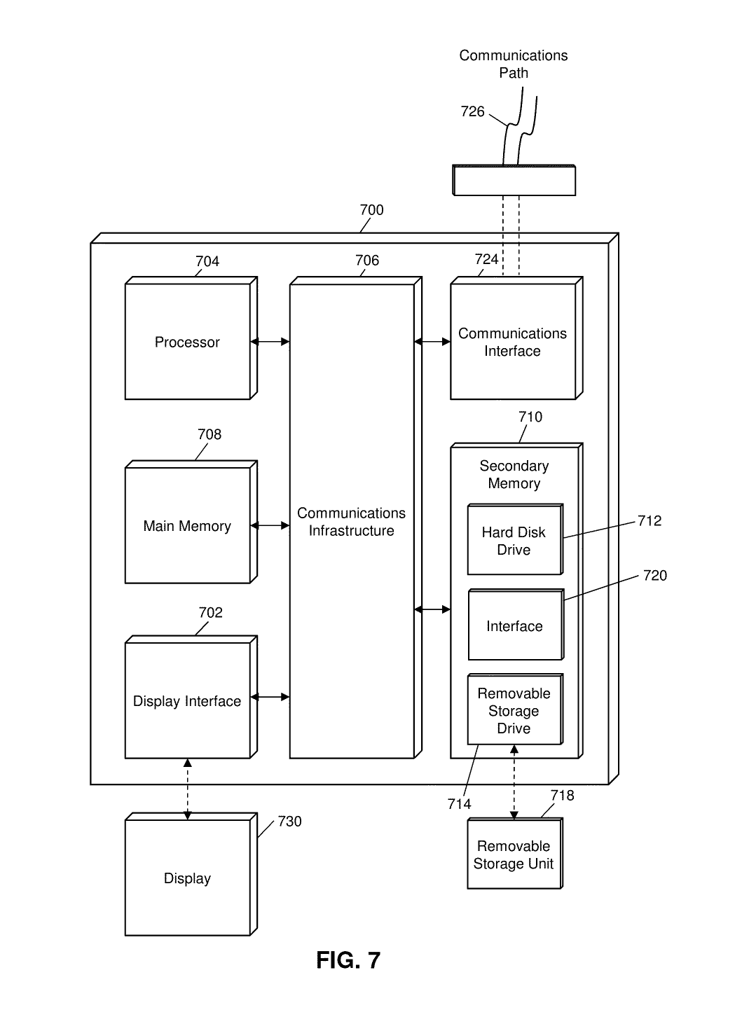

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving unit 202. The receiving unit 202 may be configured to interface (e.g., connect, communicate, etc.) with one or more networks in order to receive data, information, etc. The receiving unit 202 may receive the request for characteristic payments data from the requesting entity 110, and may also receive data for including in the transaction data entries of the transaction database 104, such as transaction data 208 (e.g., from the payment network 106), consumer information 210 (e.g., from the demographic tracking agency 108), merchant information 212, and geographic locations 214.

The processing server 102 may also include a processing unit 204. The processing unit may be configured to identify and/or analyze the data received via the receiving unit 202, such as data related to payment transactions. The processing unit 204 may store the received data in the transaction database 104 in one or more corresponding transaction data entries. As discussed above, each transaction data entry may include at least transaction data 208, consumer information 210, merchant information 212, and a geographic location 214.

The transaction data 208 may include data related to the payment transaction, such as transaction amount, transaction time and/or date, payment method, payment information, product information, or any other data suitable for the calculation of characteristic metrics based thereon as will be apparent to persons having skill in the relevant art. The consumer information 210 may include information associated with a consumer involved in the related payment transaction, such as, for example, demographic information (e.g., age, gender, family status, residential status, zip or postal code, income range, occupation, education level, etc.), or any other information associated with the consumer that may be suitable for the calculation of one or more characteristic metrics. In an exemplary embodiment, the consumer information 210 does not include any PII.

The merchant information 212 may include information associated with a merchant involved in the related payment transaction, such as merchant name, merchant location, merchant industry, merchant category code, merchant identification number, or any other suitable information that will be apparent to persons having skill in the relevant art. In an exemplary embodiment, the merchant information 212 may not include any potentially identifiable information to individually identify the associated merchant.

The geographic location 214 included in each transaction data entry may be the geographic location where the related payment transaction took place. The geographic location 214 may be represented in any format suitable for use in performing the functions discussed herein, such as latitude and longitude, street address, zip or postal code, etc. Methods for obtaining the geographic location 214 of a payment transaction will be apparent to persons having skill in the relevant art, and may include the inclusion of the geographic location 214 in an authorization request for the payment transaction submitted to the payment network 106 for authorization.

The processing unit 204 may be further configured to identify at least one characteristic metric based on at least one of the transaction data 208, consumer information 210, and merchant information 212 included in the transaction database 104. The characteristic metrics may be identified based on data included in transaction data entries with geographic locations 214 included in a geographic area specified in the request from the requesting entity 110. Metrics that may be identified based on the information in the transaction database 104 may vary widely based on application, such as transaction density, transaction amounts, merchant industries, consumer density, consumer demographics, etc. In some instances, the request may further identify representation of the requested metric, such as via a heat map, a map of discrete points, etc. For example, the requesting entity 110 may request a map of the density of transactions over $50 as represented in discrete points, as well as a heat map showing the average value of transactions over the same area. Additional metrics and representations thereof will be apparent to persons having skill in the relevant art.

The processing unit 204 may also be configured to generate a data file in a GIS file format illustrating the identified characteristic metric or metrics applied to the geographic area as provided in the request received from the requesting entity 110. The GIS file may be a shape file, raster file, or other type of file format pursuant to one or more GIS standards. Methods for generating a data file of a GIS file format will be apparent to persons having skill in the relevant art. The processing server 102 may also include a transmitting unit 206. The transmitting unit 206 may be configured to transmit the generated data file to the requesting entity 110 via one or more communication networks operating using one or more network protocols.

### Method for Providing a Privacy Compliant GIS Data File Illustrating Characteristic Data

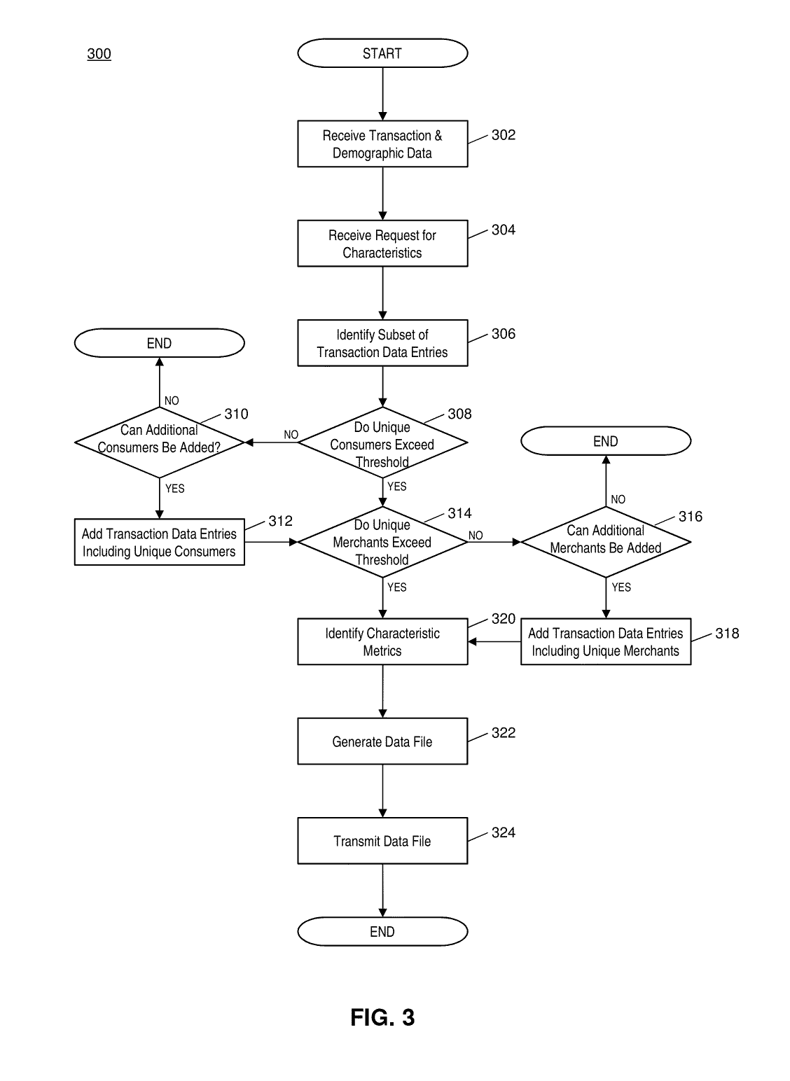

FIG. 3 illustrates a method 300 for the providing of a privacy compliant data file of a GIS file format illustrating one or more characteristic metrics to a requesting entity 110.

In step 302, the processing server 102 may receive (e.g., via the receiving unit 202) transaction data 208 and demographic data for a plurality of financial transactions, which the processing server 102 may store in the transaction database 104 as one or more transaction data entries. The demographic data may include consumer information 210 and/or merchant information 212. The transaction data 208 may include a geographic location 214 for each respective financial transaction.

In step 304, the processing server 102 may receive a request for characteristics from the requesting entity 110. The request for characteristics may include at least one requested characteristic metric and a specified geographic area. In step 306, the processing server 102 may identify a subset of transaction data entries stored in the transaction database 104 where the corresponding geographic location 214 is in the specified geographic area identified in the request for characteristics.

In step 308, the processing server 102 may determine if the number of unique consumers involved in the financial transactions related to the identified subset of transaction data entries exceeds a predetermined threshold. The predetermined consumer threshold may be a value suitable for maintaining the privacy of the consumers whose associated consumer information 210 may be used to identify the one or more characteristic metrics requested by the requesting entity 110. It will be apparent to persons having skill in the relevant art that the value of the predetermined consumer threshold may vary, based on, for example, the size of the specified geographic area, the characteristic metric(s) requested, the regulations or definitions imposed or adopted, etc.

If the number of unique consumers does not exceed the consumer threshold (e.g., more consumers are to be included for additional privacy), then, in step 310, the processing server 102 may determine if additional consumers can be added, such as via the addition of other transaction data entries. If no additional consumers can be added, then the process 300 may stop as it may be unable to generate the data file without a violation of privacy for the consumer or consumers or eliminate the specific data entry from the data file, or change the filters creating the specific data entry, as discussed in more detail below. In some instances, the transmitting unit 206 of the processing server 102 may transmit a message to the requesting entity 110 informing them of the inability to generate the data file.

If additional consumers can be added, then, in step 312, the processing server 102 may identify and add transaction data entries to the subset of transaction data entries that include additional unique consumers sufficient to satisfy the predetermined threshold. Methods for adding additional transaction data entries may include enlarging the specified geographic area, expanding the requirements of a characteristic metric (e.g., identifying transactions exceeding $45 instead of $50, etc.), or any other suitable method that will be apparent to persons having skill in the relevant art.

Once the number of unique consumers has exceeded the predetermined threshold, then, in step 314, the processing server 102 may identify if the number of unique merchants exceeds a predetermined merchant threshold. If the number of unique merchants does not exceed the threshold, then the processing server 102 may determine if more unique merchants may be added, and may identify and add transaction data entries to the subset if possible to obtain the number of unique merchants to satisfy the merchant threshold, in steps 316 and 318. In one embodiment, step 314 may also, or alternatively, include the processing server 102 identifying if the number of unique merchants exceeds a predetermined location threshold. For example, a location threshold may be specified such that the merchants identified in the corresponding area (e.g., the specified geographic area, subareas of the specified geographic area, etc.) may not be personally identifiable.

In step 320, once the subset of transaction data entries includes a sufficient number of unique consumers and a sufficient number of unique merchants to satisfy privacy concerns, the processing server 102 may identify the at least one characteristic metric requested in the request received from the requesting entity 110. The at least one characteristic metric may be based on the transaction data 208, the consumer information 210, the merchant information 212, and/or the geographic location 214 of the transaction data entries included in the subset of transaction data entries.

In step 322, the processing server 102 may generate a data file illustrating the identified at least one characteristic metric as applied to the specified geographic area. The file format of the data file may be a GIS file format, such as a shape file or a raster file. In some embodiments, a separate data file may be generated for each requested at least one characteristic metric. In other embodiments, the number and organization of data files may be indicated in the request. For example, a requesting entity 110 may request a single map of discrete points of restaurant transaction density and density of transactions exceeding $50, and a second map as a heat map showing transaction density in certain areas. In step 324, the transmitting unit 206 of the processing server 102 may transmit the generated data file(s) to the requesting entity 110.

### Data File Illustrations

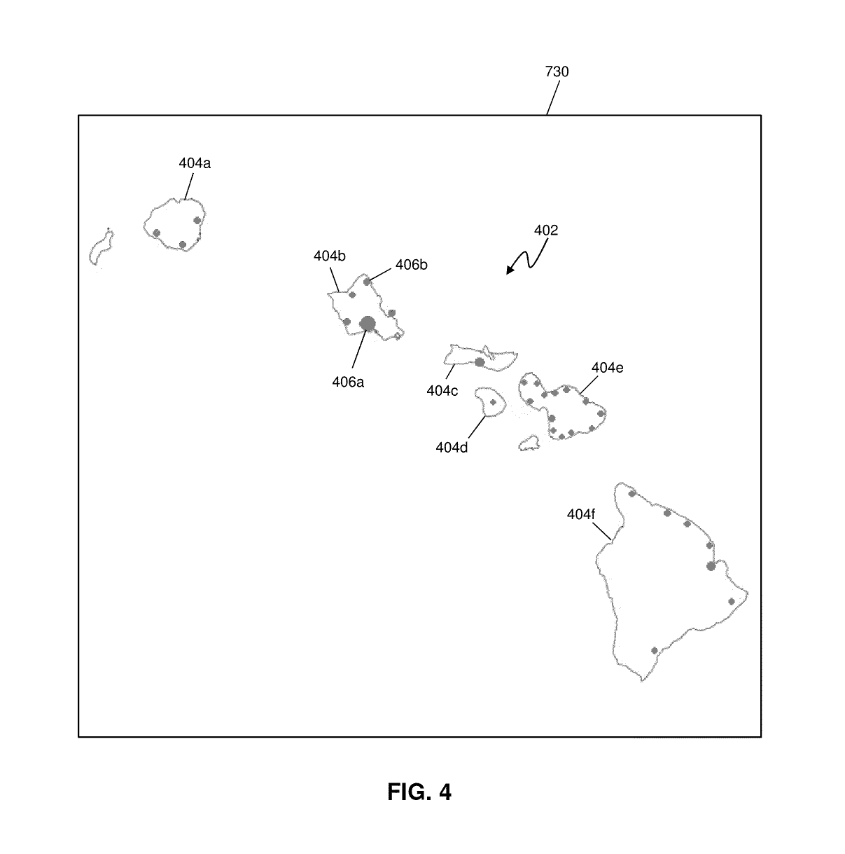

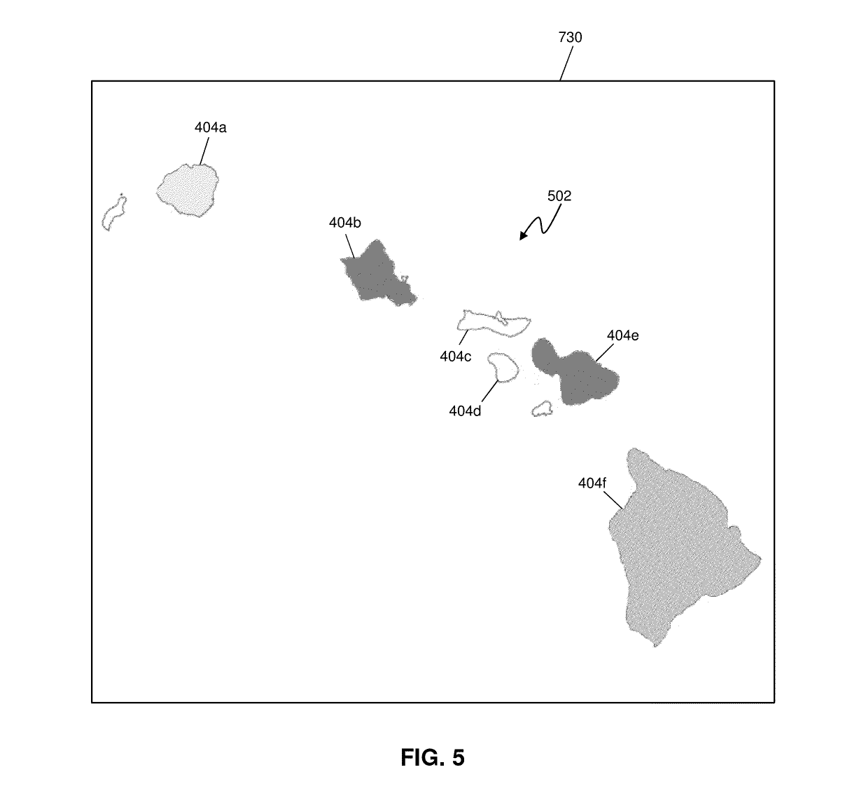

FIGS. 4 and 5 are illustrations of output of a data file generated to illustrate identified characteristic metrics applied to a specified geographic area, such as via the method 300 described above. It will be apparent to persons having skill in the relevant art that the outputs illustrated in FIGS. 4 and 5 of data files generated using the systems and methods as disclosed herein are for illustration purposes only, and that the output illustrated via the generated data files may vary greatly from application to application.

FIG. 4 includes an illustration 402 of the output of a data file generated in response to a request received from a requesting entity 110 requesting an illustration of the transaction density of food service transactions in the Hawaiian Islands. The output file may be displayed on a display 730 of a computing device, such as the display 730 of a computing device 700 discussed in more detail below. The specified geographic area included in the request may include one or more smaller geographic areas 404, illustrated as each of the islands of the Hawaiian Islands 404a, 404b, 404c, 404d, 404e, and 404f. Each of the smaller geographic areas 404 may be outlined in the generated data file as pursuant to a GIS standard as will be apparent to persons having skill in the relevant art. Thus, real world, physical transactions within a physical location are transformed into anonymized displays of characteristic metrics (e.g., spending behavior, demographics, etc.) within a display of the geographical area by applying a variety of identified characteristic metric filters. In some instances, the smaller geographic areas 404 may be specified in the request. For example, the request may specific areas as the smaller geographic areas 404, may indicate political areas (e.g., counties, states, municipalities, etc.) as the smaller geographic areas 404, or may rely on the processing server 102 to represent the data in a suitable fashion.

The data file may include data for illustrating a plurality of food service transaction densities 406, illustrated in FIG. 4 as densities 406a and 406b. It will be apparent to persons having skill in the relevant art that additional characteristic metrics may be illustrated in the output, such as by different shaped or colored icons, etc., which might be adjacent or overlapping as appropriate to the metrics of interest. As shown in FIG. 4, the illustration of the food service transaction density 406a is larger than the illustration of the food service transaction density 406b. This may indicate that there are more food service transactions occurring at the specific geographic location of density 406a than at the specific geographic location of density 406b.

FIG. 5 includes an illustration 502 of the output of a data file generated in response to the same request, but illustrated via a heat map. The heat map uses color to represent the density of food service transactions for each of the specific islands as small geographic areas 404 of the larger specified geographic area of the Hawaiian Islands. The illustration 502 shows that the island 404b has a higher density of food service transactions for the area than any other Hawaiian Island, illustrated by its darker color.

### Exemplary Method for Providing Characteristic Payments Data

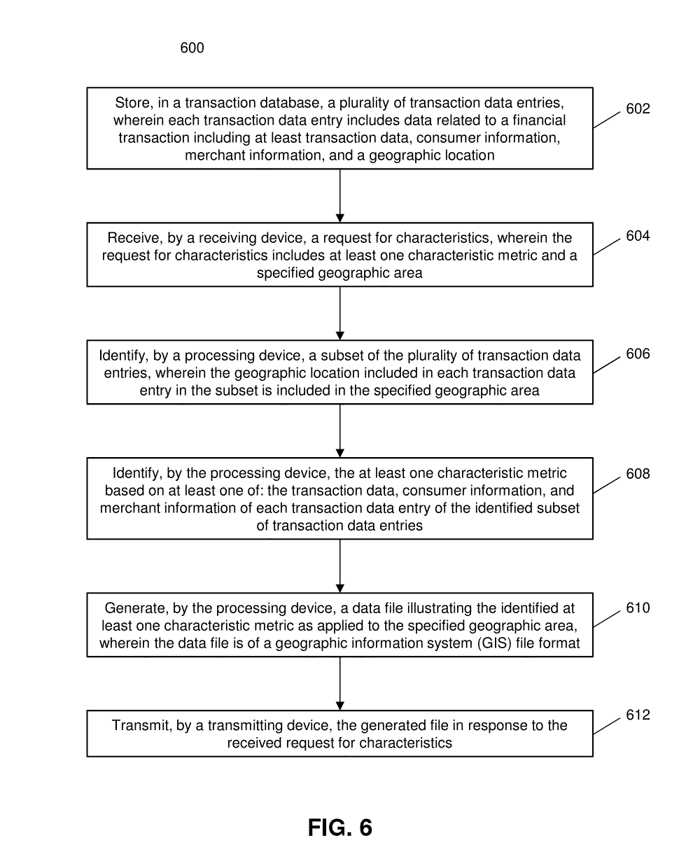

FIG. 6 illustrates a method 600 for providing characteristic payments data as a data file of a GIS file format generated to illustrate at least one characteristic metric applied to a specified geographic area while maintaining consumer and merchant privacy.

In step 602, a plurality of transaction data entries may be stored in a transaction database (e.g., the transaction database 104), wherein each transaction data entry includes data related to a financial transaction including at least transaction data (e.g., the transaction data 208), consumer information (e.g., the consumer information 210), merchant information (e.g., the merchant information 212), and a geographic location (e.g., the geographic location 214). In one embodiment, the consumer information 210 includes at least one of: an account identifier corresponding to a payment account involved in the related financial transaction and spend behavior, demographic data, or an identifier of a consumer involved in the related financial transaction, wherein the consumer information 210 is not personally identifiable information of the consumer. In another embodiment, the merchant information may include at least one of: a merchant identifier, merchant name, merchant address, merchant category code, merchant industry, product information, product data, and a geographic area associated with a merchant involved in the financial transaction.

In step 604, a request for characteristics may be received, by a receiving device (e.g., the receiving unit 202), wherein the request for characteristics includes at least one characteristic metric and a specified geographic area. In one embodiment, the at least one characteristic metric is one of: various types or specifically identified demographic information, spend behavior, and payments data. In a further embodiment, the demographic information includes at least one of: age, gender, familial status, relationship status, income, type of residence, residential location, employment industry, employment location, and education. In another further embodiment, the spend behavior includes at least one of: spend frequency, transaction frequency, spend amount, propensity to spend, and propensity to redeem offers.

In step 606, a subset of the plurality of transaction data entries may be identified, by a processing device (e.g., the processing unit 204), wherein the geographic location 214 included in each transaction data entry in the subset is included in the specified geographic area. In some embodiments, the consumer information 210 may identify a consumer involved in the related financial transaction, and the number of unique consumers identified in the consumer information 210 included in each of the transaction data entries in the identified subset may exceed a predetermined consumer threshold. In a further embodiment, the predetermined consumer threshold may be a minimum value of the number of unique consumers. In another embodiment, the merchant information 212 may identify a merchant involved in the related financial transaction, and the number of unique merchants identified in the merchant information 212 included in each of the transaction data entries in the identified subset may exceed a predetermined merchant threshold. In a further embodiment, the predetermined merchant threshold may be included in the request for characteristics. In yet another embodiment, the merchant information 212 may identify a merchant involved in the related financial transaction, and the number of unique merchants identified in the merchant information 212 included in each of the transaction data entries in the identified subset may exceed a predetermined location threshold.

In step 608, the at least one characteristic metric may be identified, by the processing unit 204, based on at least one of: the transaction data 208, the consumer information 212, and the merchant information 212 of each transaction data entry of the identified subset of transaction data entries. In step 610, a data file may be generated, by the processing unit 204, illustrating the identified at least one characteristic metric as applied to the specified geographic area, wherein the data file is of a geographic information system (GIS) file format. In one embodiment, the data file is one of a shape file or a raster file. In step 612, a transmitting device (e.g., the transmitting unit 206) may transmit the generated file in response to the received request for characteristics.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communication infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive, the removable storage unit 718 may be a floppy disk. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 718 and an interface 720. Examples of such means may include a program cartridge and cartridge interface (e.g., as found in video game systems), a removable memory chip (e.g., EEPROM, PROM, etc.) and associated socket, and other removable storage units 718 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

Computer program medium and computer usable medium may refer to memories, such as the main memory 708 and secondary memory 710, which may be memory semiconductors (e.g. DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3 and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for providing characteristic payments data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for providing characteristic payments data, comprising:
storing, in a transaction database, a plurality of transaction data entries, wherein each transaction data entry includes data related to a financial transaction including at least transaction data, consumer information, merchant information, and a geographic location;
receiving, by a receiving device, a request for characteristics, wherein the request for characteristics includes at least one characteristic metric and a specified geographic area;
identifying, by a processing device, a subset of the plurality of transaction data entries, wherein the geographic location included in each transaction data entry in the subset is included in the specified geographic area;
identifying, by the processing device, the at least one characteristic metric based on at least one of: the transaction data, consumer information, and merchant information of each transaction data entry of the identified subset of the plurality of transaction data entries;
generating, by the processing device, a data file illustrating the identified at least one characteristic metric as applied to the specified geographic area, wherein the data file is of a geographic information system (GIS) file format; and
transmitting, by a transmitting device, the generated data file in response to the received request for characteristics.

2. The method of claim 1, wherein
the merchant information identifies a merchant involved in the related financial transaction, and
a number of unique merchants identified in the merchant information included in each of the transaction data entries in the identified subset of the plurality of transaction data entries exceeds a predetermined location threshold.

3. The method of claim 1, wherein
the consumer information identifies a consumer involved in the related financial transaction, and
a number of unique consumers identified in the consumer information included in each of the transaction data entries in the identified subset of the plurality of transaction data entries exceeds a predetermined consumer threshold.

4. The method of claim 2, wherein the predetermined consumer threshold is a minimum value of the number of unique consumers such that none of the unique consumers are personally identifiable.

5. The method of claim 1, wherein
the merchant information identifies a merchant involved in the related financial transaction, and
a unique number of merchants identified in the merchant information included in each of the transaction data entries in the identified subset of the plurality of transaction data entries exceeds a predetermined merchant threshold.

6. The method of claim 5, wherein the predetermined merchant threshold is included in the request for characteristics.

7. The method of claim 1, wherein the at least one characteristic metric is one of: demographic information, spend behavior, and payments data.

8. The method of claim 7, wherein the demographic information includes at least one of: age, gender, familial status, relationship status, income, type of residence, residential location, employment industry, employment location, and education.

9. The method of claim 7, wherein the spend behavior includes at least one of: spend frequency, transaction frequency, spend amount, propensity to spend, and propensity to redeem offers.

10. The method of claim 1, wherein the consumer information includes at least one of: an account identifier corresponding to a payment account involved in the related financial transaction and spend behavior, demographic data, or an identifier of a consumer involved in the related financial transaction, wherein the consumer information is not personally identifiable information of the consumer.

11. The method of claim 1, wherein the merchant information includes at least one of: a merchant identifier, merchant name, merchant address, merchant category code, merchant industry, product information, product data, and a geographical area associated with a merchant involved in the financial transaction.

12. The method of claim 1, wherein the data file is one of: a shape file or a raster file.

13. A system for providing characteristic payments data, comprising:
a transaction database configured to store a plurality of transaction data entries, wherein each transaction data entry includes data related to a financial transaction including at least transaction data, consumer information, merchant information, and a geographic location;
a receiving device configured to receive a request for characteristics, wherein the request for characteristics includes at least one characteristic metric and a specified geographic area;
a processing device configured to
identify a subset of the plurality of transaction data entries, wherein the geographic location included in each transaction data entry in the subset is included in the specified geographic area,
identify the at least one characteristic metric based on at least one of: the transaction data, consumer information, and merchant information of each transaction data entry of the identified subset of the plurality of transaction data entries, and
generate a data file illustrating the identified at least one characteristic metric as applied to the specified geographic area, wherein the data file is of a geographic information system (GIS) file format; and
a transmitting device configured to transmit the generated data file in response to the received request for characteristics.

14. The system of claim 13, wherein
the merchant information identifies a merchant involved in the related financial transaction, and
a number of unique merchants identified in the merchant information included in each of the transaction data entries in the identified subset of the plurality of transaction data entries exceeds a predetermined location threshold.

15. The system of claim 13, wherein
the consumer information identifies a consumer involved in the related financial transaction, and
a number of unique consumers identified in the consumer information included in each of the transaction data entries in the identified subset of the plurality of transaction data entries exceeds a predetermined consumer threshold.

16. The system of claim 13, wherein the predetermined consumer threshold is a minimum value of the number of unique consumers such that none of the unique consumers are personally identifiable.

17. The system of claim 13, wherein
the merchant information identifies a merchant involved in the related financial transaction, and
a unique number of merchants identified in the merchant information included in each of the transaction data entries in the identified subset of the plurality of transaction data entries exceeds a predetermined merchant threshold.

18. The system of claim 17, wherein the predetermined merchant threshold is included in the request for characteristics.

19. The system of claim 13, wherein the at least one characteristic metric is one of: demographic information, spend behavior, and payments data.

20. The system of claim 19, wherein the demographic information includes at least one of: age, gender, familial status, relationship status, income, type of residence, residential location, employment industry, employment location, and education.

21. The system of claim 19, wherein the spend behavior includes at least one of: spend frequency, transaction frequency, spend amount, propensity to spend, and propensity to redeem offers.

22. The system of claim 13, wherein the consumer information includes at least one of: an account identifier corresponding to a payment account involved in the related financial transaction and spend behavior, demographic data, or an identifier of a consumer involved in the related financial transaction, wherein the consumer information is not personally identifiable information of the consumer.

23. The system of claim 13, wherein the merchant information includes at least one of: a merchant identifier, merchant name, merchant address, merchant category code, merchant industry, product information, product data, and a geographical area associated with a merchant involved in the financial transaction.

24. The system of claim 13, wherein the data file is one of: a shape file or a raster file.
